(19) United States
(12) Patent Application Publication
(10) Pub. No.: US 2025/0262766 A1
(43) Pub. Date: Aug. 21, 2025

(54) ROBOT PROGRAMMING DEVICE AND PROGRAMMING METHOD

(71) Applicant: FANUC CORPORATION, Yamanashi (JP)

(72) Inventor: Shunta Ozaki, Yamanashi (JP)

(21) Appl. No.: 19/196,017

(22) Filed: May 1, 2025

Related U.S. Application Data
(63) Continuation of application No. PCT/JP2023/010107, filed on Mar. 15, 2023.

(51) Int. Cl. B25J 9/16

(52) U.S. Cl. CPC B25J 9/1671; B25J 9/161

(57) ABSTRACT

A device and method with which it is easy to perform a setting indicating whether some commands should be skipped when a program is executed. A programming device for creating or editing an operation program for a robot includes a display unit for displaying a plurality of operation symbols respectively representing a plurality of operation commands included in the operation program; and an input unit for accepting user operations with respect to the operation symbols displayed on the display unit. The display unit is configured to display, in response to a specified operation by the user, an execution setting change image that enables the user to perform a setting indicating whether a command included in an operation symbol selected by the user is to be skipped when the operation program is executed.

### CROSS-REFERENCE TO RELATED APPLICATIONS

This application is a bypass continuation application of International Application No. PCT/JP2023/010107 filed Mar. 15, 2023.

### BACKGROUND

### Field

The present disclosure relates to a programming device and a programming method for a robot.

### Discussion of the Related Art

In the field of robot programming, a programming technique using icons is well known. In this technique, an operator can use a mobile terminal, etc., to generate or edit a robot program by locating iconized commands on a timeline and/or by manipulating icons displayed on a screen.

In addition, a technique for skipping some commands in a robot program based on a predetermined condition has been proposed.

In programming a robot, when an operation of a robot program is to be checked, it may be desirable to skip some of the commands in the program without executing them. In such a case, possible approaches include adding a branch statement to the program so that some of the commands are skipped, or by deleting the relevant commands and then adding them back in through re-teaching. However, each of these approaches is time-consuming and inconvenient.

Therefore, there is a need for a device and method which can easily set whether or not some commands should be skipped when a program is executed.

### SUMMARY

One aspect of the present disclosure provides a programming device configured to generate or edit an operation program for a robot, the programming device comprising: a display unit configured to display a plurality of operation symbols respectively representing a plurality of operation commands included in the operation program; and an input unit configured to accept an operation by a user with respect to the operation symbol displayed on the display unit, wherein the display unit is configured to display, in response to a specified operation by the user, an execution setting change image by which the user can set as to whether the operation command included in the operation symbol selected by the user is to be skipped when the operation program is executed.

Another aspect of the present disclosure provides a programming method for generating or editing an operation program for a robot, the method comprising: displaying a plurality of operation symbols respectively representing a plurality of operation commands included in the operation program on a display unit; and accepting an operation by a user with respect to the operation symbol displayed on the display unit, wherein the display unit is configured to display, in response to a specified operation by the user, an execution setting change image by which the user can set as to whether the operation command included in the operation symbol selected by the user is to be skipped when the operation program is executed.

### BRIEF DESCRIPTION OF DRAWINGS

FIG. 1 is a schematic configuration view of a system including a programming device according to an embodiment.

FIG. 2 is a view showing a first example of the programming device.

FIG. 3 is a view showing a state in which some commands are commented out in FIG. 2.

FIG. 4 is a view showing a second example of the programming device.

FIG. 5 is a view showing a display example of an image prompting a user to confirm commenting out or uncommenting a command.

FIG. 6 is a view showing a state in which some commands are commented out in FIG. 4.

FIG. 7 is a view showing a third example of the programming device.

FIG. 8 is a view showing a state in which a plurality of icons are selected.

### DETAILED DESCRIPTION OF THE EMBODIMENTS

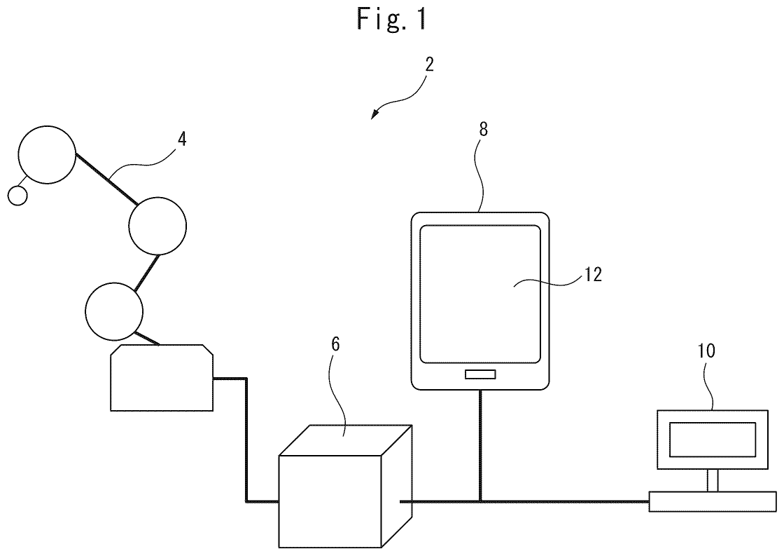

FIG. 1 is a schematic configuration view of a robot system including a programming device according to an embodiment. The robot system 2 includes an industrial robot 4 such as a vertical articulated robot, a robot controller 6 having a processor and a memory, etc., and configured to control the robot 4, and a teaching device 8 such as a teach pendant communicably connected to the robot controller 6 by wire or wirelessly.

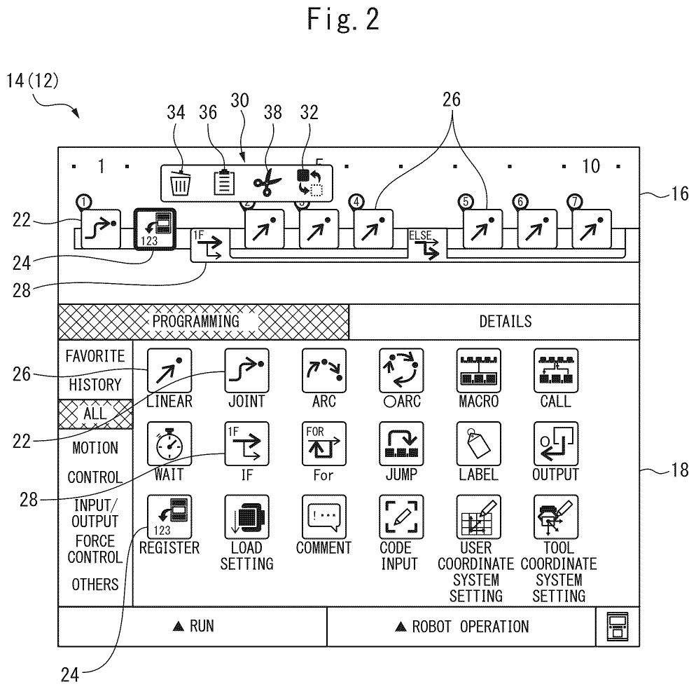

Hereinafter, with reference to FIGS. 2 to 8, the means and procedures for generating and editing the operation program for the robot will be described. In this embodiment, the teaching device 8 functions as a programming device configured to generate or edit the operation program for the robot, and the user can input various kinds of information for generating and editing the operation program via a user interface (UI) 14 displayed on a display 12 of the teaching device 8. In other words, the display 12 functions as a display unit by which the user can visually recognize the various kinds of information, and the UI 14 functions as an input unit configured to accept various inputs and operations from the user.

### First Example

The display 12 is configured to display icons as a plurality of operation symbols respectively representing a plurality of operation commands included in the operation program. The UI 14 includes a timeline display area 16 in which the icons displayed on the display 12 can be displayed in chronological order, and a menu display area 18 in which each icon can be displayed so that the user can select a desired icon. In the first example, it is assumed that the user generates a desired robot program by arranging an icon (joint) 22 including a command to move each axis of the robot, an icon (register) 24 including a command to execute a process of reading a predetermined value from a memory, etc., an icon (linear) 26 including a command to linearly move a representative point (e.g., a tool center point) of the robot, and an icon (If) 28 for conditional branching, in the timeline display area 16 by an operation such as drag and drop.

In this regard, when executing the generated program, it is assumed that it is necessary or desirable to skip the command included in the icon 24. For example, when checking the operation of the program, it may be desirable to execute only the command required for the operation check to efficiently check the operation. In such a case, when the user first selects the icon 24 not required for the operation check by tapping, etc., the icon 24 is highlighted by changing its color or shading, and a pop-up menu 30 is displayed as exemplified in FIG. 2. The menu 30 includes figures and/or symbols which visualize various processes for the selected icon 24, and in this example, includes an execution setting change image (button) 32 for commenting out/uncommenting as described below, and buttons 34, 36 and 38 for deleting, copying or cutting (to move) the selected icon, respectively.

When the user operates the execution setting change button 32 by pressing or tapping while the icon 24 is selected, the status of the command included in the icon 24 is changed. Specifically, when the button 32 is operated when the command of the icon 24 is in a state in which it will be executed when the program is executed, the command of the icon 24 is put into a state in which it will not be executed when the program is executed. Herein, this operation is also referred to as “comment(ing) out”. Thus, in the first example, when the operating program is executed, after the process of the icon 22 is executed, the process of the icon 24 is not executed, and next the process of the icon 28 is executed.

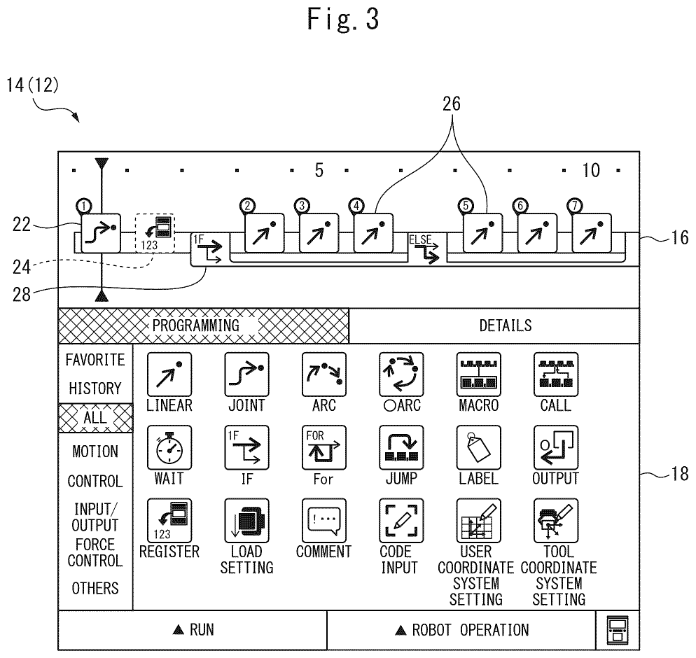

In this way, by simply selecting a specific icon and operating the execution setting change button, it is possible to skip the command contained in that icon and execute the program. As exemplified in FIG. 3, it is preferable that the appearance of the selected icon 24, more specifically, its color and shade, be changed by commenting out it from before commenting out, so that the user can easily visually recognize that the icon 24 has been commented out.

On the other hand, when the command of the icon 24 is not to be executed when the program is executed (i.e., when the icon 24 is commented out), operating the button 32 causes the command of the icon 24 to be executed when the program is executed. Herein, this operation is also referred to as “uncomment(ing)”. Since the uncommenting can be performed with a simple operation in this way, it is also extremely easy to restore the skipped command (to be executed when the program is executed).

It is preferable that the information of the commented out icon (command) be stored in a suitable memory, so that the icon which has been uncommented can be executed immediately.

### Second Example

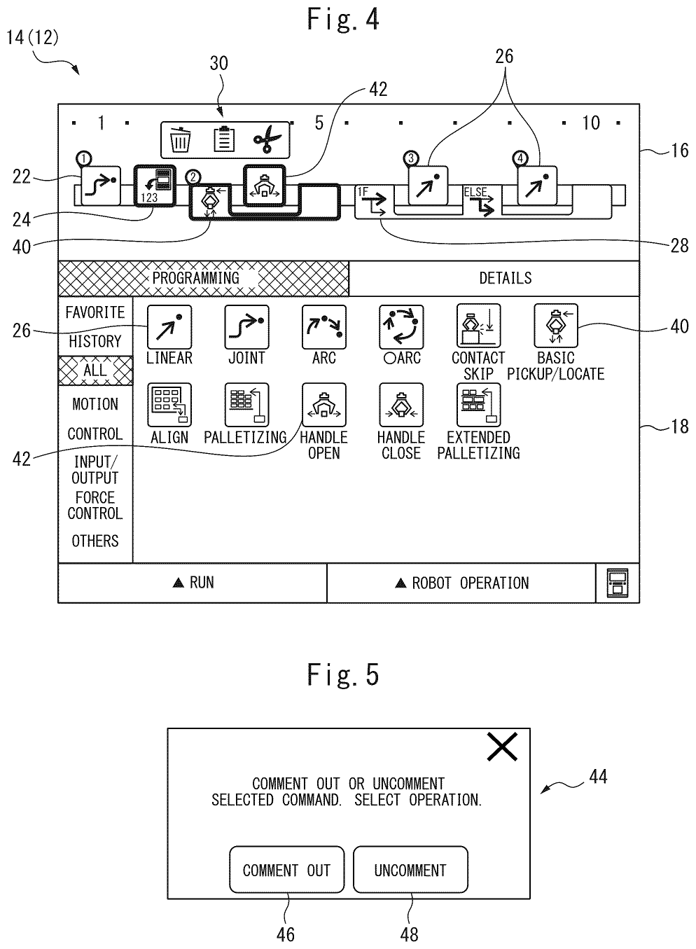

FIG. 4 shows an example of commenting or uncommenting a plurality of icons at the same time. Note that the description of the second example that may be the same as the first example will be omitted.

In the second example, it is assumed that an operating program has been generated in which the icon (register) 24 containing a command to execute a process of reading a specified value from the memory, etc. is followed by an icon (pickup/locate) 40 containing a command to pickup a workpiece using a robot hand, and an icon (handle open) 42 containing a command to release the picked workpiece.

In this regard, it is assumed that, when executing the generated program, it becomes necessary or desirable to skip the commands included in the icons 24, 40 and 42. In this case, when the user selects the icons 24, 40 and 42 by successive tapping operations, etc., the icons 24, 40 and 42 are highlighted by changing their color or shading, and further, a confirmation image (execution setting change image) 44 is displayed in place as exemplified in FIG. 5.

When the user selects the “comment out” button 46 included in the confirmation image 44 by tapping, etc., the commands included in the icons 24, 40 and 42 are commented out and are skipped and not executed when the program is executed. It is preferable to store information with respect to the commented out icons (commands) in a suitable memory.

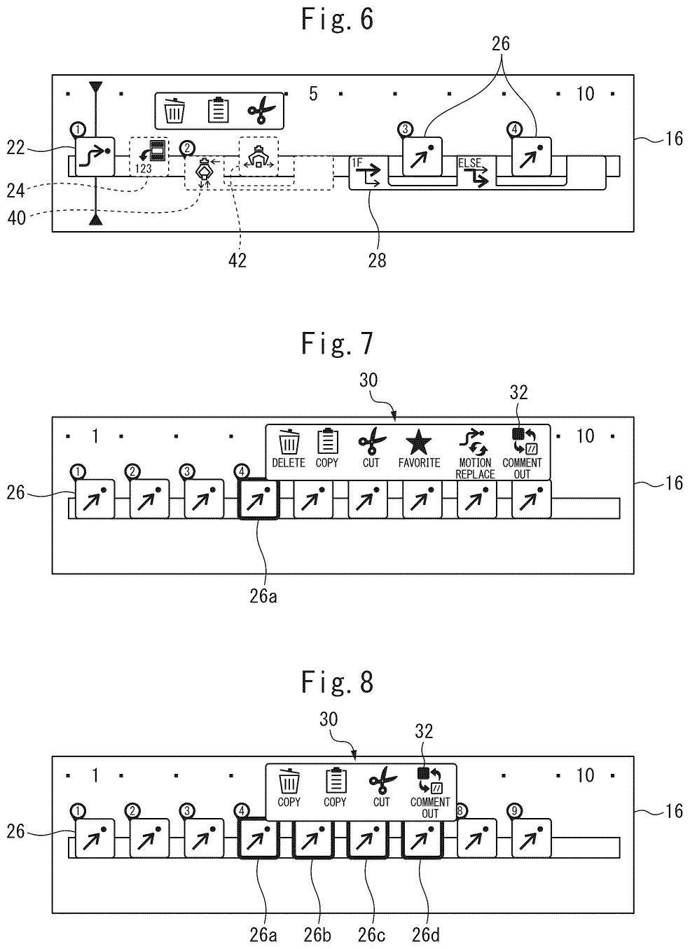

In this way, it is possible to execute the program by skipping the commands contained in the icons by a simple operation of selecting the icons and selecting the comment out button 46 from the confirmation image 44. As exemplified in FIG. 6, it is preferable that the appearance (color and/or shade, etc.) of the selected icons 24, 40 and 42 changes after being commented out from that before being commented out, so that the user can easily visually recognize that the icons 24, 40 and 42 have been commented out.

On the other hand, when icons 24, 40 and 42 are commented out, selecting these icons and selecting the “uncomment” button 48 in the confirmation image 44 by tapping, etc., will uncomment the commands contained in icons 24, 40 and 42, and they will be executed without being skipped when the program is executed. In this way, the plurality of icons can also be commented out or uncommented by the simple operation of the user.

### Third Example

FIGS. 7 and 8 show another example of simultaneously commenting out or uncommenting a plurality of icons. Note that the description of the third example that may be the same as the first example will be omitted. In the third example, it is assumed that a robot program is generated which includes a plurality of icons (linear) 26 each including a command to linearly move the robot.

In this regard, it is assumed that, when executing the generated program, it becomes necessary or desirable to skip some of the plurality of icons 26. In this case, the user first performs a predetermined operation such as long press or double click on one of the icons to be skipped (an icon 26a in this case). Then, as shown in FIG. 7, the icon 26a is highlighted and the menu 30 including the execution setting change button 32 is displayed.

When the button 32 is operated in the state of FIG. 7, only the selected icon 26a is commented out. However, from the state of FIG. 7, by selecting the other icons 26b, 26c and 26d to be skipped by tapping, etc., the icons 26a, 26b, 26c and 26d are highlighted as shown in FIG. 8. By operating the button 32 in this state, the icons 26a, 26b, 26c and 26d can be collectively commented out. The same operation may be used to uncomment the icons.

According to the present disclosure, when executing the operation program for the robot generated by arranging the plurality of icons on the timeline, each of which includes the operation command for the robot, the user can perform a process for skipping (commenting out) the command included in some of the icons with the simple operation via the UI, and can also uncomment the command with the similarly simple operation. Therefore, the programming device which is extremely useful in a case where it is not necessary to execute some of the commands, such as when checking the operation of the program, is provided.

In the above embodiment, although the teaching device 8 functions as the programming device configured to generate or edit the operation program of the robot, the present disclosure is not limited as such. For example, the PC 10 shown in FIG. 1 may also be used as the programming device. At least one of the teaching device 8, the controller 6 and the PC 10 may also function as an execution device configured to execute the generated or edited operation program.

Although the present disclosure has been described in detail, the present disclosure is not limited to the above-mentioned individual embodiments. Various additions, replacements, modifications, partial deletions, etc. are possible for these embodiments within the scope of the gist of the present disclosure, or within the scope of the gist of the present disclosure derived from the contents described in the claims and their equivalents. These embodiments can also be implemented in combination. For example, in the above-mentioned embodiments, the order of each operation and the order of each process are shown as examples, and are not limited to these. The same applies when numerical values or formulas are used in the description of the above-mentioned embodiments.

The following supplementary clauses are further disclosed regarding the above-described embodiment and modified examples.

### Clause 1

A programming device configured to generate or edit an operation program for a robot, the programming device comprising: a display unit configured to display a plurality of operation symbols respectively representing a plurality of operation commands included in the operation program; and an input unit configured to accept an operation by a user with respect to the operation symbol displayed on the display unit, wherein the display unit is configured to display, in response to a specified operation by the user, an execution setting change image by which the user can set as to whether the operation command included in the operation symbol selected by the user is to be skipped when the operation program is executed.

### Clause 2

The programming device according to clause 1, wherein the display unit is configured to display each operation symbol in a different appearance, depending on whether the operation symbol is set to be skipped or executed when the operation program is executed.

### Clause 3

A programming method for generating or editing an operation program for a robot, the method comprising: displaying a plurality of operation symbols respectively representing a plurality of operation commands included in the operation program on a display unit; and accepting an operation by a user with respect to the operation symbol displayed on the display unit, wherein the display unit is configured to display, in response to a specified operation by the user, an execution setting change image by which the user can set as to whether the operation command included in the operation symbol selected by the user is to be skipped when the operation program is executed.

REFERENCE SIGNS LIST

| | |
|---|---|
| 2 | robot system |
| 4 | robot |
| 6 | controller |
| 8 | teach pendant |
| 10 | PC |
| 12 | display unit |
| 14 | user interface |
| 16 | timeline display area |
| 18 | menu display area |
| 22, 24, 26, 28, 40, 42 | icon |
| 30 | menu |
| 32, 34 | execution setting change image |
| 46 | comment out button |
| 48 | uncomment button |

What is claimed is:

1. A programming device configured to generate or edit an operation program for a robot, the programming device comprising:
a display unit configured to display a plurality of operation symbols respectively representing a plurality of operation commands included in the operation program; and
an input unit configured to accept an operation by a user with respect to the operation symbol displayed on the display unit,
wherein the display unit is configured to display, in response to a specified operation by the user, an execution setting change image by which the user can set as to whether the operation command included in the operation symbol selected by the user is to be skipped when the operation program is executed.

2. The programming device according to claim 1, wherein the display unit is configured to display each operation symbol in a different appearance, depending on whether the operation symbol is set to be skipped or executed when the operation program is executed.

3. A programming method for generating or editing an operation program for a robot, the method comprising:
displaying a plurality of operation symbols respectively representing a plurality of operation commands included in the operation program on a display unit; and
accepting an operation by a user with respect to the operation symbol displayed on the display unit,
wherein the display unit is configured to display, in response to a specified operation by the user, an execution setting change image by which the user can set as to whether the operation command included in the operation symbol selected by the user is to be skipped when the operation program is executed.
